(19) United States
(12) Patent Application Publication
(10) Pub. No.: US 2023/0397009 A1
(43) Pub. Date: Dec. 7, 2023

(54) METHOD FOR PAIRING AN APPARATUS WITH A TERMINAL DEVICE AND ARRANGEMENT FOR SAME

(71) Applicant: Körber Technologies GMBH, Hamburg (DE)

(72) Inventor: Michael Joseph Capone

(21) Appl. No.: 18/249,685

(22) PCT Filed: Oct. 20, 2021
(86) PCT No.: PCT/EP2021/079025

§ 371 Date: Apr. 19, 2023

(30) Foreign Application Priority Data
Oct. 22, 2020 (DE) 102020127828.4

(51) Int. Cl. H04W 12/50; H04W 4/80; A24F 40/65; A24F 40/50

(52) U.S. Cl. CPC H04W 12/50; H04W 4/80; A24F 40/65; A24F 40/50

(57) ABSTRACT

A method for pairing, via Bluetooth, an apparatus, comprising at least one illumination means, with a terminal device, comprising a sensor, comprises positioning the apparatus and the terminal device within a maximum Bluetooth range; establishing a connection between the illumination means and the sensor; setting the apparatus and the terminal device to a pairing readiness mode; generating and emitting an encoding sequence as a light signal by means of the illumination means; receiving the light signal by the sensor and converting the same to a received encoding sequence; transmitting the received encoding sequence by means of Bluetooth from the terminal device to the apparatus; checking the received encoding sequence transmitted via Bluetooth to the apparatus by means of a comparison with the encoding sequence and, if the comparison finds a match between the encoding sequence and the received encoding sequence, authorizing linking of the apparatus to the terminal device.

### CROSS-REFERENCE TO RELATED APPLICATIONS

This application is the U.S. National Stage of PCT/EP2021/079025 filed on Oct. 20, 2021, which claims priority to German Patent Application 102020127828.4 filed on Oct. 22, 2020, the entire content of both are incorporated herein by reference in their entirety.

### FIELD OF THE INVENTION

The present invention relates to a method for pairing an apparatus with a terminal device via Bluetooth. The invention further relates to an arrangement having an apparatus and a Bluetooth-enabled terminal device.

### BACKGROUND OF THE INVENTION

Nowadays, many apparatuses are equipped with a Bluetooth interface and can be wirelessly connected via this interface to a terminal device, for example a smartphone. First of all, this requires linking the apparatus to the terminal device for the first time according to the Bluetooth standard. This process is referred to as pairing. During this pairing process, it is usually necessary for the user to agree to the pairing of both devices by entering a PIN. In principle, there are various ways of providing this PIN, for example the PIN can be enclosed in printed form with the apparatus to be paired and the user is prompted to enter it via the terminal device during the pairing process. Another option is that the apparatus to be paired outputs a PIN number via its own display device during the pairing process which the user then enters on the terminal device. It is also possible that a program is pre-installed on the terminal device which is used to access a website to verify the PIN.

Although the Bluetooth standard regularly only allows one terminal device to be paired with the respective apparatus, the Bluetooth connection between the two devices is visible to third parties. This makes such connections easy to attack, for example by an MITM attack (man in the middle). In addition, the PIN numbers are often only four digits long so that third parties can use the respective apparatus to obtain the PIN number required for pairing by means of trial and error (brute force attack). Overall, the known pairing process is comparatively insecure. The use of longer PIN numbers would result in a significant loss of convenience for the user, since the probability of input errors increases with the length of the PIN number.

### SUMMARY OF THE INVENTION

It is therefore the object of the present invention to propose a method which ensures the most secure Bluetooth pairing possible of an apparatus with a terminal device while providing the greatest possible user convenience. The object is additionally to propose a corresponding arrangement.

The object is achieved by a method with the features referred to hereinbefore in that the apparatus is a mobile inhaler, in particular an e-cigarette, comprising a Bluetooth-enabled interface and at least one electrically controllable illumination means, and the terminal device comprising at least one light-sensitive optoelectronic sensor, comprising the steps: Positioning the apparatus and the terminal device within the maximum Bluetooth radio range, establishing a line-of-sight connection between the illumination means of the apparatus and the sensor of the terminal device, putting the apparatus and the terminal device into a pairing readiness mode, generating an encoding sequence and emitting same as a light signal by means of the illumination means of the apparatus, receiving the light signal by means of the optoelectronic sensor of the terminal device and converting same to a received encoding sequence, transmitting the received encoding sequence by means of Bluetooth from the terminal device to the apparatus, checking the received encoding sequence transmitted via Bluetooth to the apparatus by means of a comparison with the encoding sequence and, if the comparison finds a match between the encoding sequence and the received encoding sequence, authorizing linking of the apparatus to the terminal device by means of Bluetooth.

The present invention offers a number of advantages. Thus, on the one hand, pairing of the apparatus with the terminal device is only possible when both are located within sight of each other. This significantly increases security against pairing with devices of third parties which is otherwise possible. Another advantage is that the encoding sequence is transmitted from the apparatus to the terminal device by means of the light signal. Due to automated transmission of the encoding sequence by means of light, it is possible to exchange correspondingly long encoding sequences between the apparatus and the terminal device, which sequences offer significantly increased security against the attacks referred to hereinbefore. For the user, the pairing process according to the invention offers a high level of convenience as there is no need at all to manually enter a PIN or the like.

An expedient embodiment of the invention is characterized in that a camera of the terminal device is used as an optoelectronic sensor for receiving the light signal. This has the advantage that the camera, which is usually present anyway, is used to receive the light signal on terminal devices, in particular mobile terminal devices such as smartphones.

A preferred development of the invention is characterized in that the encoding sequence is randomly generated. Generation of a randomized encoding sequence has the advantage that a new separate code is generated for each pairing process. If third parties become aware of the encoding sequence once it has been generated, for example by recording the encoding sequence emitted by means of the illumination means of the apparatus, it cannot be used again for a new pairing process. This additionally increases security against unauthorized coupling processes.

A further expedient embodiment of the invention is characterized in that the encoding sequence is generated in such a manner that the encoding sequence comprises redundant portions. Advantageously, this increases the robustness of the encoding sequence against possible transmission errors. In particular, the redundant portions of the encoding sequence are thus adapted in such a manner that they can be used for error correction and/or error detection. For example, the encoding sequence is coded using Hamming, Reed-Solomon or BCH codes. Alternatively, convolutional codes can also be used as the encoding sequence.

A further expedient embodiment of the invention is characterized in that the redundant portions are removed on converting the light signal received into a received encoding sequence. As described above, the redundant portions of the encoding sequence are adapted in particular for error correction and/or error detection. According to the relevant encoding process, the redundant portions are removed again on the receiving side on generating the encoding sequence.

The object is further achieved by a corresponding arrangement having the features referred to hereinbefore, in that the apparatus, which is in particular a mobile inhaler or an e-cigarette, comprises a Bluetooth-enabled interface and at least one electrically controllable illumination means, and wherein the terminal device comprises at least one light-sensitive, optoelectronic sensor, and wherein the apparatus comprises a code generator, which is adapted to generate an encoding sequence, and a control device for actuating the illumination means, which is adapted to emit the encoding sequence as a light signal, and wherein the terminal device is adapted to receive the light signal by means of the optoelectronic sensor and to convert same into a received encoding sequence, wherein the terminal device is further adapted to transmit the received encoding sequence by Bluetooth to the apparatus, and wherein the apparatus comprises a checking unit which is configured and adapted to check the received encoding sequence transmitted via Bluetooth to the apparatus by means of a comparison with the encoding sequence and, if the comparison finds a match between the encoding sequence and the received encoding sequence, authorizing linking of the apparatus to the terminal device by means of Bluetooth. The advantages associated with the arrangement according to the invention have already been described in detail above based on the method according to the invention. To avoid repetition, reference is made at this point in connection with the arrangement according to the invention to the merits of the method according to the invention mentioned above. They also apply by analogy to the arrangement according to the invention.

A preferred development of the invention is characterized in that a camera of the terminal device is set up as an optoelectronic sensor for receiving the light signal.

According to a further preferred embodiment of the invention, the code generator comprises a random generator which is adapted to randomly generate the encoding sequence.

A further expedient embodiment of the invention is characterized in that the code generator is adapted to generate the encoding sequence in such a manner that the encoding sequence comprises redundant portions.

According to a further preferred embodiment of the invention, the terminal device is adapted such that the redundant portions are removed on converting the light signal received into a received encoding sequence.

A further expedient embodiment of the invention is characterized in that the code generator and the terminal device are adapted to use the redundant portions for error correction.

For the advantageous embodiments of the arrangement according to the invention referred to above, with regard to their advantages, reference is also made to the remarks above concerning the merits of the method according to the invention. These apply to the said advantageous embodiment of the arrangement according to the invention in the same way as to the merits of the advantageous embodiment of the method according to the invention already described above.

### BRIEF DESCRIPTION OF THE DRAWINGS

Further preferred and/or expedient features and embodiments of the invention emerge from the description. Particularly preferred embodiments are explained in greater detail with reference to the attached drawing. The drawing shows:

FIG. 1 a schematic illustration of apparatus and terminal device; and

FIG. 2 a flow chart of the method steps according to the invention.

### DETAILED DESCRIPTION OF THE INVENTION

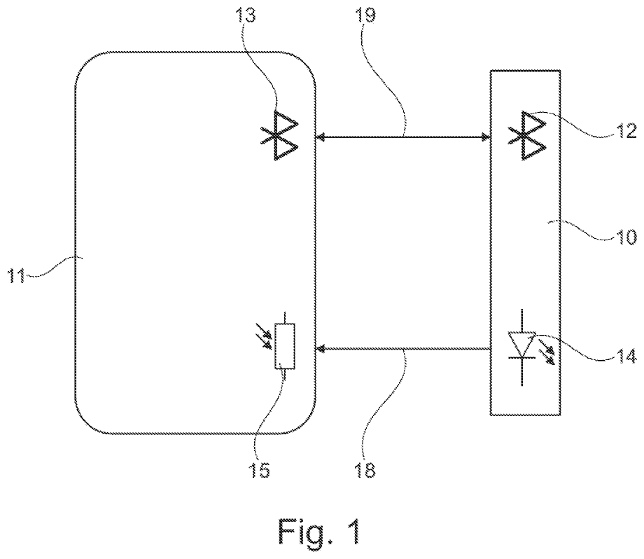

FIG. 1 shows schematically an apparatus 10, which is configured in particular as a mobile inhaler or as an e-cigarette, and a terminal device 11, for example a smartphone or a tablet PC. The apparatus 10 comprises a Bluetooth-enabled interface 12 and the terminal device 11 comprises a Bluetooth-enabled interface 13. The apparatus 10 also comprises an electrically controllable lighting means 14, for example in the form of an LED. For example, if the apparatus 10 has an illuminated display, the display can advantageously act as the lighting means 14. Thus, the signal is emitted by controlling the lightness/darkness of the display. The terminal device 11 comprises at least one light-sensitive, optoelectronic sensor 15.

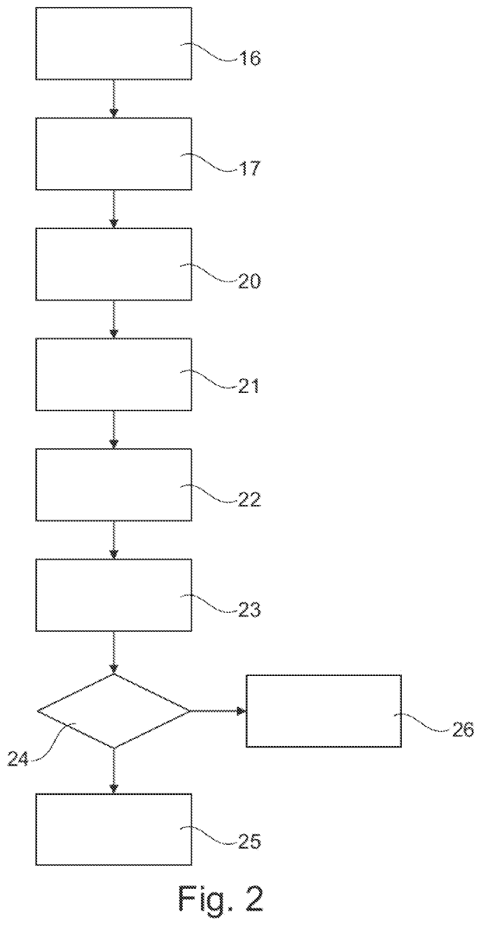

The steps of the method according to the invention shown in FIG. 2 are followed to pair the apparatus 10 with the terminal device 11 via Bluetooth.

First, it is necessary in a positioning step 16 to arrange the apparatus 10 and the terminal device 11 within the maximum Bluetooth radio range. In a second step 17, a line-of-sight connection 18 is established between the illumination means 14 of the apparatus 10 and the sensor 15 of the terminal device 11. The apparatus 10 and the terminal device 11 are thus positioned in such a manner that it is possible to create both a Bluetooth connection 19 and the line-of-sight connection 18.

In a third step 20, the apparatus 10 and the terminal device 11 are put into a pairing readiness mode. In this pairing readiness mode, both devices are adapted according to the Bluetooth standard to pair with the respective other Bluetooth device, i.e. to perform pairing.

In a transmission step 21, first an encoding sequence is generated and the same is emitted as a light signal by means of the illumination means 14 of the apparatus 11. In step 22 of the method according to the invention, the light signal is received by means of the optoelectronic sensor 15 of the terminal device 11 and converted into a received encoding sequence.

Subsequently, in step 23, the received encoding sequence is transmitted back to the apparatus 10 by means of the Bluetooth connection 19. In a comparison step 24, the received encoding sequence transmitted to the apparatus 10 is compared with the encoding sequence and a check is made to determine whether the received encoding sequence matches the encoding sequence. If this comparison results in a match between the decoding sequence and the received encoding sequence, a linking step 25 causes the apparatus 10 to be permanently linked to the terminal device 11 by means of Bluetooth. If the comparison results in a discrepancy between the two sequences, a terminate step 26 prevents the apparatus 10 from pairing with the terminal device 11 via Bluetooth by terminating the process.

A camera of the terminal device 11 is preferably used as the optoelectronic sensor 15 for receiving the light signal. For example, the encoding sequence is Morse code. More preferably, generation of the encoding sequence is randomized.

More preferably, the encoding sequence is generated in such a manner that the encoding sequence comprising redundant portions. For example, the encoding sequence is a Hamming, Reed-Solomon or BCH code. Alternatively, the encoding sequence is set up as a convolutional code.

The redundant portions are preferably removed on converting the light signal received into a received encoding sequence, in particular the relevant portions for error correction or error detection.

The schematic illustration of FIG. 1 also shows the arrangement according to the invention in detail. As shown, the arrangement comprises the apparatus 10 and the Bluetooth-enabled terminal device 11. The apparatus 10 comprises the Bluetooth-enabled interface 12 and at least one electrically controllable illumination means 14, while the terminal device 11 comprises at least one light-sensitive, optoelectronic sensor 15. The apparatus 10 also comprises a code generator, not shown in the drawing, which is adapted to generate an encoding sequence and a control device, also not shown in the drawing, for actuating the illumination means 14.

The terminal device 11 is further adapted to receive the light signal by means of the optoelectronic sensor and to convert same into a received encoding sequence. The terminal device 11 is further adapted to transmit the received encoding sequence by means of Bluetooth to the apparatus 10. Furthermore, the apparatus 10 comprises a checking unit—not shown in the drawing—which is configured and adapted to check the received encoding sequence transmitted via Bluetooth to the apparatus 10 by means of a comparison with the encoding sequence and, if this comparison finds a match between the encoding sequence and the received encoding sequence, to authorize linking of the apparatus 10 to the terminal device 11 by means of Bluetooth. Advantageously, a camera of the terminal device 11 is adapted as the optoelectronic sensor 15 for receiving the light signal.

More preferably, the code generator comprises a random generator which is adapted to randomly generate the encoding sequence. In particular, the code generator is adapted to generate the encoding sequence in such a manner that the encoding sequence comprises the redundant portions. In turn, the terminal device 11 is preferably adapted to remove the redundant portions on converting the light signal received into a received encoding sequence. In this case, the code generator and the terminal device are adapted to use the redundant portions for error correction and/or error detection.

Optionally, the line-of-sight connection 18 shown in FIG. 1 is not only unidirectional but also adapted for bidirectional data transmission. In this case, the apparatus 10 comprises a further sensor means, not shown in the drawing, and the terminal device 11 comprises a further electrically adapted illumination means. Embodiment of the optical interface as a bidirectional interface has a number of advantages when transmitting the encoding sequence from the apparatus 10 to the terminal device 11, for example for transmitting synchronization and/or handshake signals. It is also possible to use the bidirectional optical interface for encryption when transmitting the encoding sequence to make the pairing process more secure overall.

1-12. (canceled)

13. A method for pairing an apparatus with a terminal device via Bluetooth, wherein the apparatus comprises a Bluetooth-enabled interface and at least one electrically controllable illumination means, and wherein the terminal device comprises at least one light-sensitive optoelectronic sensor, the method comprising the following steps:
positioning the apparatus and the terminal device within a maximum Bluetooth radio range;
establishing a line-of-sight connection between the electrically controllable illumination means of the apparatus and the light-sensitive optoelectronic sensor of the terminal device;
setting the apparatus and the terminal device to a pairing readiness mode;
generating an encoding sequence and emitting the same as a light signal by means of the electrically controllable illumination means of the apparatus;
receiving the light signal by means of the light-sensitive optoelectronic sensor of the terminal device and converting the same to a received encoding sequence;
transmitting the received encoding sequence by means of Bluetooth from the terminal device to the apparatus;
checking the received encoding sequence transmitted via Bluetooth to the apparatus by means of a comparison with the encoding sequence and, if the comparison finds a match between the encoding sequence and the received encoding sequence, authorizing linking of the apparatus to the terminal device by means of Bluetooth.

14. The method of claim 13, wherein the apparatus is a mobile inhaler or an e-cigarette.

15. The method of claim 13, wherein a camera of the terminal device is used as the light-sensitive optoelectronic sensor for receiving the light signal.

16. The method of claim 13, wherein the encoding sequence is randomly generated.

17. The method of claim 13, wherein the encoding sequence is generated in such a manner that the encoding sequence comprises redundant portions.

18. The method of claim 17, wherein the redundant portions are removed on converting the light signal received into a received encoding sequence.

19. The method of claim 17, wherein the redundant portions are used for error correction.

20. An arrangement having an apparatus and a Bluetooth-enabled terminal device, wherein:
the apparatus comprises a Bluetooth-enabled interface and at least one electrically controllable illumination means;
the terminal device comprises at least one light-sensitive optoelectronic sensor;
the apparatus comprises a code generator, which is adapted to generate an encoding sequence, and a control device for actuating the electrically controllable illumination means, which is adapted to emit the encoding sequence as a light signal;
the terminal device is adapted to receive the light signal by means of the light-sensitive optoelectronic sensor and to convert the same into a received encoding sequence;
the terminal device is further adapted to transmit the received encoding sequence by means of Bluetooth to the apparatus; and
the apparatus comprises a checking unit which is configured and adapted to check the received encoding sequence transmitted via Bluetooth to the apparatus by means of a comparison with the encoding sequence and, if the comparison finds a match between the encoding sequence and the received encoding sequence, to authorize linking of the apparatus to the terminal device by means of Bluetooth.

21. The arrangement of claim 20, wherein the apparatus is a mobile inhaler or an e-cigarette.

22. The arrangement of claim 20, wherein a camera of the terminal device is adapted as the light-sensitive optoelectronic sensor for receiving the light signal.

23. The arrangement of claim 20, wherein the code generator comprises a random generator which is adapted to randomly generate the encoding sequence.

24. The arrangement of claim 20, wherein the code generator is adapted to generate the encoding sequence in such a manner that the encoding sequence comprises redundant portions.

25. The arrangement of claim 24, wherein the terminal device is adapted to remove the redundant portions when converting the light signal received into the received encoding sequence.

26. The arrangement of claim 24, wherein the code generator and the terminal device are adapted to use the redundant portions for error correction.
